(19) United States
(12) Patent Application Publication
(10) Pub. No.: US 2006/0110212 A1
(43) Pub. Date: May 25, 2006

(54) Parking stand for two-wheeled vehicle

(75) Inventors: Takuji Masui, Sakai City (JP); Shun Hayakawa, Toyonaka City (JP)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Shimano Inc., Osaka (JP)

(21) Appl. No.: 10/987,012

(22) Filed: Nov. 11, 2004

(51) Int. Cl. F16B 7/10

(52) U.S. Cl. 403/53

(57) ABSTRACT

An adjustable vehicle parking stand is described. The parking stand includes first and second members. The first member has a first member axis defining an axial direction. The first member also a first engagement edge with a slope in the axial direction. The second member is rotatable about the first member axis and has a second engagement edge with a slope in-the axial direction. The second engagement edge abuttingly engages the first engagement edge.

### FIELD OF THE INVENTION

The present invention relates generally to parking stands for two-wheeled vehicles, and more particularly, to extendible parking stands.

### BACKGROUND OF THE INVENTION

Two-wheeled vehicles such as bicycles and motorcycles frequently use parking stands or kick-stands as a means of supporting the vehicle when it is parked. Such known parking stands typically comprise an elongated member which is pivotally attached to a vehicle frame at a first end. The elongated member typically has a free end for contacting the ground when the vehicle is parked. While the vehicle is being ridden, the parking stand is typically secured parallel to the vehicle frame to avoid interfering with the vehicle's travel, and in the case of a bicycle, to avoid interfering with the rotation of the pedals. When the vehicle is parked, the free end of the parking stand is pivoted downward to a parking position such that the free end engages the ground. In the parking position, the free end is typically spaced apart from the vehicle frame so that the angle of orientation between the parking stand and the frame is sufficient to support the vehicle's weight and prevent it from falling over.

When riding a bicycle, it is sometimes desirable to leave the parking stand in the parking position while the bicycle is pushed forward or backward. To accomplish this, it is desirable to ensure that while in the parking position, the parking stand does not interfere with the rotational orbit of the pedals. Otherwise, the rotation of the wheels will cause the pedals to rotate until one of them abuts against the parking stand, preventing the rider from moving the bicycle further.

Known parking stands frequently have a fixed length. However, the parking stand length that is necessary to support the vehicle when it is parked may be undesirably long when the vehicle is being ridden. While extendible parking stands have been developed, they frequently require the rider to use his or her hands to adjust the stand length. This adjustment can be particularly difficult to make, especially if the rider needs to support the weight of the vehicle while making it. Thus, a need has arisen for a parking stand that addresses the foregoing issues.

### SUMMARY OF THE PREFERRED EMBODIMENTS

In accordance with a first aspect of the present invention, a parking stand is provided. The parking stand comprises a first member having a first member axis defining an axial direction. The parking stand also comprises an unthreaded second member which is operatively connected to the first member and rotatable about the first member axis, wherein rotating the second member about the first member axis causes the second member to move in the axial direction relative to the first member. In a preferred embodiment, the second member includes a support portion spaced apart from the first member, and the support portion projects away from the first member axis. In other preferred embodiments, the second member is biased with respect to the first member in the axial direction.

In accordance with another aspect of the present invention, a parking stand is provided which comprises a first member having a first member axis defining an axial direction. The first member has a first engagement edge with a slope in the axial direction. The parking stand further comprises a second member having a second engagement edge with a slope in the axial direction. The second member is rotatable about the first member axis, and the second engagement edge abuttingly engages the first engagement edge.

In a preferred embodiment, the first engagement edge abuttingly engages the second engagement edge such that rotating the second member about the first member axis causes the second member to move in the axial direction relative to the first member. In other preferred embodiments, one of the first and second members has a boss, the other of the first and second members has a slot with a slope in the axial direction, and the boss engages the slot. In additional preferred embodiments, the parking stand has a compact position and an expanded position, and the slot has a first end defining the compact position and a second end defining the expanded position.

In further preferred embodiments, the first member and second members each have an inner surface and an outer surface, the boss projects away from the outer surface of one of the first and second members, and the slot is defined in the inner surface of the other of the first and second members.

In still other preferred embodiments, the second member has a support portion spaced apart from the first member, and the support portion projects away from the first member axis. In yet other preferred embodiments, the rotation of the second member causes the boss to travel along the slot.

In additional preferred embodiments, the member having a boss further has an outer surface and an aperture, and the boss is biased through the aperture in a direction away from the outer surface. In further preferred embodiments, the first end of the slot has a first end aperture, and in the compact position, the boss projects through the first end aperture. In other preferred embodiments, the second end of the slot has a second end aperture, and in the expanded position, the boss projects through the second end aperture.

In accordance with another aspect of the present invention, a parking stand is provided which comprises first and second members. One of the first and second members is rotatable relative to the other of the first and second members. The first member has a first member axis defining an axial direction and further has a first member slot with a slope in the axial direction. The second member has a second member boss. The second member boss is engaged with the first member slot such that rotating one of the first and second members about the first member axis causes the rotated member to move in the axial direction relative to the other of the first and second members.

### BRIEF DESCRIPTION OF THE DRAWINGS

The invention may be more readily understood by referring to the accompanying drawings in which:

FIG. 1 is a partial side elevational view of a bicycle frame with a parking stand in both parking position and riding position, in accordance with a first preferred embodiment of the present invention;

FIG. 1a is a detail view of the parking stand of FIG. 1;

FIG. 2 is an exploded view of parking stand in accordance with a second preferred embodiment of the present invention;

FIG. 2a is a cross-sectional view taken along the line x-x in FIG. 2;

FIG. 3 is an exploded view of a parking stand in accordance with a third preferred embodiment of the present invention;

FIG. 4 is an exploded view of a parking stand in accordance with a fourth preferred embodiment of the present invention;

FIG. 5 is an exploded view of a parking stand in accordance with a fifth preferred embodiment of the present invention;

FIG. 6 is a bottom plan view of the parking stand of FIG. 1 in the riding position as viewed from the rear of the bicycle;

FIG. 6a is a side elevation view of a portion of the parking stand of FIGS. 1 and 6 in the parking position;

FIG. 7 is a side elevation view of a bicycle crank and a portion of the parking stand of FIG. 1; and

FIG. 8 is an exploded view of a sixth preferred embodiment of a parking stand in accordance with the present invention.

Like numerals refer to like parts throughout the several views of the drawings.

### DETAILED DESCRIPTION OF THE PREFERRED EMBODIMENTS

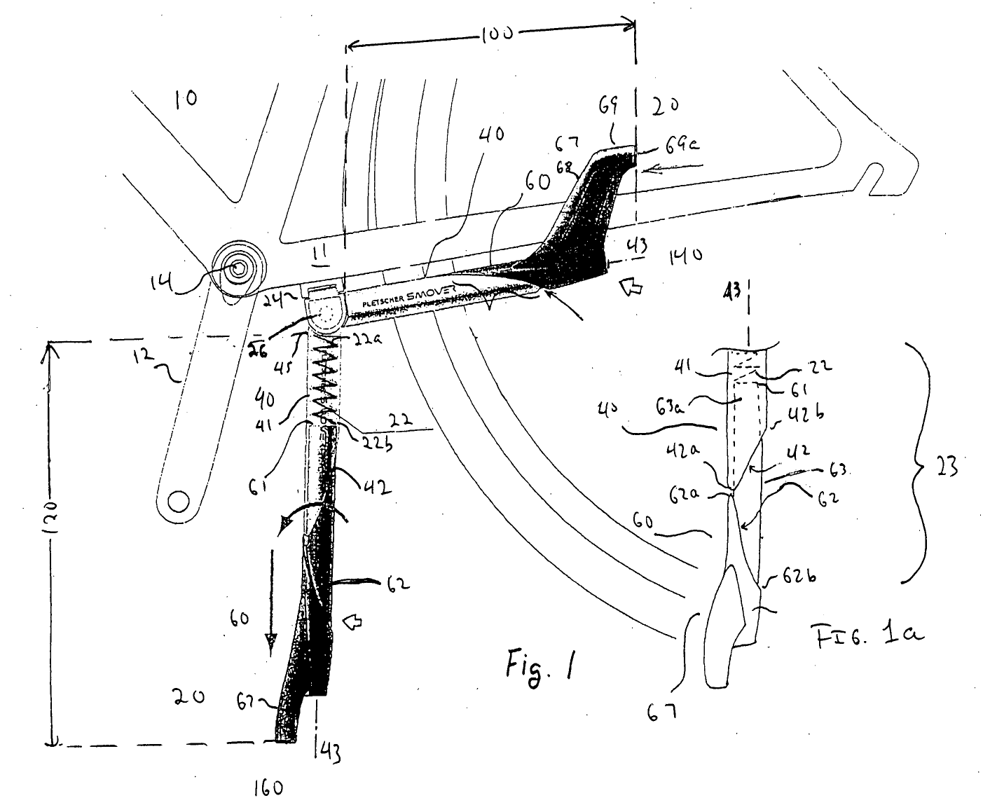

Referring to FIG. 1, a bicycle having a frame 10 with a parking stand is provided to illustrate a first preferred embodiment of the present invention. Frame 10 includes crank 12 with pedal 13 (not shown). To ride the bicycle, the rider rotates crank 12 about crank axis 14. The rotation of crank 12 rotates the rear wheels of the bicycle via a chain and sprocket assembly (not shown) or other known means.

To facilitate parking and storage of the bicycle, parking stand 20 is provided. The parking stand depicted in FIG. 1 may be used with a variety of different vehicles, and is particularly well-suited for use with two-wheeled vehicles, such as bicycles and motorcycles.

Parking stand 20 is preferably constructed from known materials, such as aluminum or steel. Parking stand 20 is preferably pivotally attached at a first end 45 to a pivot bracket 24 by a pin or other known device suitable for pivotal attachment, and pivot bracket 24 is fixedly attached to frame 10. FIG. 1 shows parking stand 20 in two different positions, a riding position 140 and a parking position 160. While in riding position 140, parking stand 20 is positioned such that it is substantially parallel to frame 10 and adjacent frame member 11, with its free-end, ground engaging end 69a, positioned away from the ground. In contrast, while in the-parking position 160, parking stand 20 is substantially perpendicular to adjacent frame member 11. To move parking stand 20 from the riding position 140 to the parking position 160, the rider preferably applies a clockwise rotational force (when viewing the parking stand from the side of the bicycle depicted in FIG. 1) to parking stand 20 sufficient to pivot it about pivot axis 26.

Parking stand 20 is preferably designed to have a compact position 100, and an expanded position 120. In accordance with this embodiment, parking stand 20 is adjustable between two lengths, with a shorter length defining compact position 100 and a longer length defining expanded position 120. As described further below, the parking stand 20 of this embodiment is adjustable between compact position 100 and expanded position 120 by rotatably adjusting a portion of parking stand 20.

Referring to FIG. 1a, parking stand 20 has an elongated cylindrical portion 23 and a laterally projecting portion 67. Parking stand 20 further comprises a proximal member 40, located proximally to pivot bracket 24, and a distal member 60, located distally from pivot bracket 24.

As shown in FIGS. 1 and 1a, proximal member 40 is preferably an elongated, partially-cylindrical member having a longitudinal axis 43. Proximal member 40 also has an axially sloping edge 42 which is spaced apart from first end 45. Edge 42 has a point 42a which is at a maximum distance from first end 45 and a point 42b which is at a minimum distance from first end 45.

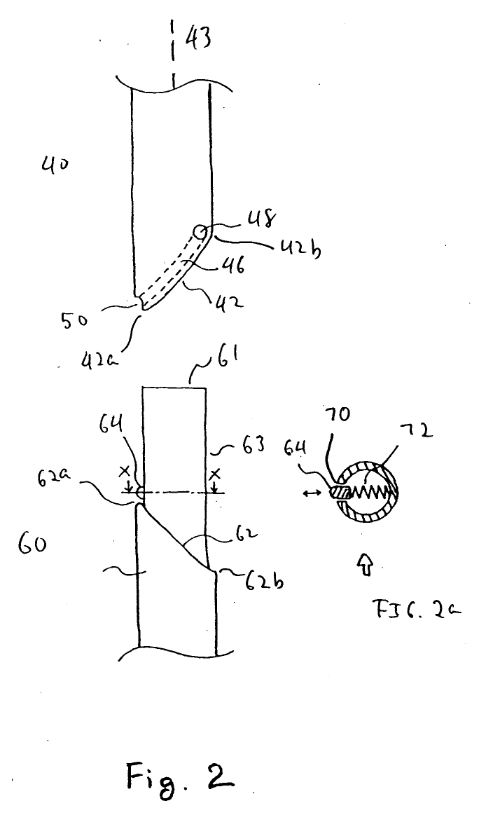

Distal member 60 has a first end 61 located on a cylindrical portion 63. Proximal member 40 preferably includes an interior space 41 which is hollow and which is dimensioned to accommodate a portion 63a of distal member 60 (shown in phantom in FIG. 2) therein. More preferably, portion 63a of distal member 60 which is disposed in interior space 41 is concentric with proximal member 40 and has the same longitudinal axis 43 as proximal member 40. A biasing spring 22 is preferably located in interior space 41. Spring 22 is preferably attached at a first end 22a to first end 45 of proximal member 40 in the interior space 41. Spring 22 is preferably attached at a second end 22b to an outer surface of first end 61 of distal member 60 to connect distal member 60 to proximal member 40. Spring 22 preferably biases distal member 60 towards proximal member 40. Spring 22 is attached to proximal member 40 and distal member 60 by any suitable means known in the art. Spring 22 is also preferably selected and attached so as to minimize rotational biasing of distal member 60 with respect to proximal member axis 43.

As with the proximal member 40 of this embodiment, distal member 60 also has an axially sloping edge 62 formed along its length away from first end 61 and facing toward proximal member 40. Edge 62 is preferably integrally formed with distal member 60 and preferably has a slope with respect to axis 43. As a result, edge 62 has a first point 62a which is at a minimum distance from first end 61 and a second point 62b which is at a maximum distance from first end 61.

As mentioned above, in the embodiment of FIGS. 1 and 1a, proximal member 40 is preferably hollow and distal member 60 is partially disposed within it. As a result, engagement edge 62 is spaced apart from first end 61 of distal member 60. However, as will be apparent to those of ordinary skill in the art, the structures of proximal member 40 and distal member 60 could be reversed such that proximal member 40 is partially disposed within distal member 60.

In accordance with this embodiment, distal member 60 is rotatable about axis 43 and is rotatable with respect to proximal member 40. The rotation of distal member 60 about proximal member axis 43 causes distal member 60 to move away from proximal member 40 in the direction of proximal member-axis 43.

As mentioned above, proximal member 40 and distal member 60 of this preferred embodiment each have engagement edges 42 and 62 which abuttingly engage one another. In accordance with this embodiment, proximal member 40 is not rotatable about proximal member axis 43. Because proximal member 40 is not rotatable, when distal member 60 is rotated about proximal member axis 43, distal member engagement edge 62 begins to travel along proximal member engagement edge 42. Because engagement edges 42 and 62 are sloped in the axial direction with respect to axis 43, as distal member 60 is rotated, its engagement edge 62 abuttingly engages engagement edge 42 at variable axial locations along proximal member 40. This engagement at variable axial locations causes distal member 60 to move axially with respect to proximal member 40. For example, when the parking stand 20 is in its compact position 100, point 62a on the engagement edge 62 of distal member 60 engages point 42b on the engagement edge 42 of proximal member 40. As distal member 60 is rotated about axis 43, point 62a contacts proximal member 40 at points along engagement edge 42 which are progressively farther from first end 45 of proximal member 40. Once points 62a and 42a abuttingly engage one another, the axial movement of distal member 60 is at its maximum. At that point, reversing the rotation of distal member 60 will cause distal member 60 to axially move closer to proximal member 40.

As shown in FIGS. 1 and 1a, distal member 60 and proximal member 40 are preferably unthreaded. Thus, the parking stand 20 of this embodiment allows for rotational adjustment of the parking stand's length without the need for threadedly engaging distal member 60 with proximal member 40.

In the embodiment of FIG. 1, it is especially preferred that point 42a on proximal member 40 and the point 62a be shaped or designed to keep parking stand 20 in the expanded position 120 until it is desired return it to compact position 100. In one embodiment, depicted in FIG. 8, lower peak 42a is notched to engage upper peak 62a on the engagement edge 62 of distal member to provide this functionality. Alternatively, peaks 42a and 62a may be relatively flat so that they stably abut one another when parking stand 20 is in its expanded position 120.

In the embodiment of FIGS. 1 and 1a, engagement edge 42 has a single lower peak 42a and engagement edge 62 has a single upper peak 62a. However, alternate profiles which utilize axially sloped engagement edges may be used. For example, in the preferred embodiment of FIG. 8, proximal member 40 has two axially sloped edges 42 and 95, each having its own lower and upper peaks, 42a and 42b, and 95a and 95b, respectively. In addition, proximal member 40 has two vertically linear engagement edges 47 and 49. Distal member 60 has two axially sloped edges 62 and 65 (not shown) which abuttingly engage the corresponding engagement edges 42 and 95 on proximal member 40. Distal member 60 similarly includes two corresponding vertically linear engagement edges 61a and 61b (not shown). In the embodiment of FIG. 8, when parking stand 20 is in its compact position 100, distal member may only be rotated about axis 43 in the direction indicated by the arrow in FIG. 8 (i.e., clockwise when viewed from above). The abutting engagement of linear edges 61a and 47 and the abutting engagement of linear edges 61b and 49 prevents the rotation of distal member 60 in the opposite direction when starting from compact position 100.

Referring to FIG. 2, a parking stand 20 is described in accordance with a second preferred embodiment of the present invention. As with the previous embodiment, the parking stand 20 of FIG. 2 has a compact state 100 and an expanded state 120, as well as a riding position 140 and a parking position 160. Proximal member 40 is partially cylindrical and includes engagement edge 42 which is sloped with respect to proximal member axis 43. Biasing spring 22 (not shown in FIG. 2) is also preferably included and is attached as described with respect to FIGS. 1 and 1a to bias distal member 60 toward proximal member 40. Again, distal member 60 includes a cylindrical portion 63 and an axially-sloped edge 62 spaced apart from first end 61.

To further facilitate the rotational engagement of distal member 60 with proximal member 40, proximal member 40 includes a slot 46 (shown in phantom). As shown in the figure, slot 46 is preferably integrally formed in the inner surface of proximal member 40 and is sloped in the axial direction. It is especially preferred that proximal member 40 include two apertures or through-bores 48 and 50 located at opposite ends of slot 46. Distal member 60 preferably includes a boss 64 or other protrusion located on its cylindrical portion 63 and above its engagement edge 62. Boss 64 and slot 46 are dimensioned to engage one another such that boss 64 may slidably travel along slot 46.

As best seen in FIG. 2a, distal member 60 preferably includes an aperture 70 through which boss 64 projects. Even more preferably, a boss biasing spring 72 is provided to bias boss 64 through aperture 70 in a direction away from the outer surface of distal member 60.

When the parking stand 20 of FIG. 2 is assembled and in its compact state 100, the biasing action of boss biasing spring 72 causes boss 64 to project through aperture 48 of the inner surface of proximal member 40, thereby releasably locking parking stand 20 into compact state 100. As distal member 60 is rotated, boss 64 is pressed inward of aperture 48 by the inner surface of proximal member 40. Boss 64 then begins to travel along slot 46 towards slot end 50. The engagement of boss 64 with axially-sloped slot 46, as well as the engagement of engagement edges 42 and 62 causes distal member 60 to move away from proximal member 40 in the direction of axis 43. Once boss 64 reaches aperture 50, rotation is complete and the biasing action of boss biasing spring 72 causes boss 64 to project through aperture 50, thereby releasably locking parking stand 20 into its expanded position 120.

A number of different configurations of engagement edges and/or slots and bosses may be used without departing from the scope and spirit of the present invention, and the embodiments described herein are merely preferred. However, it is especially preferred that distal member 60 and proximal member 40 are configured such that the parking stand can be adjusted from its compact state 100 to its expanded state 120 by rotating one of the members 40 or 60 about axis 43.

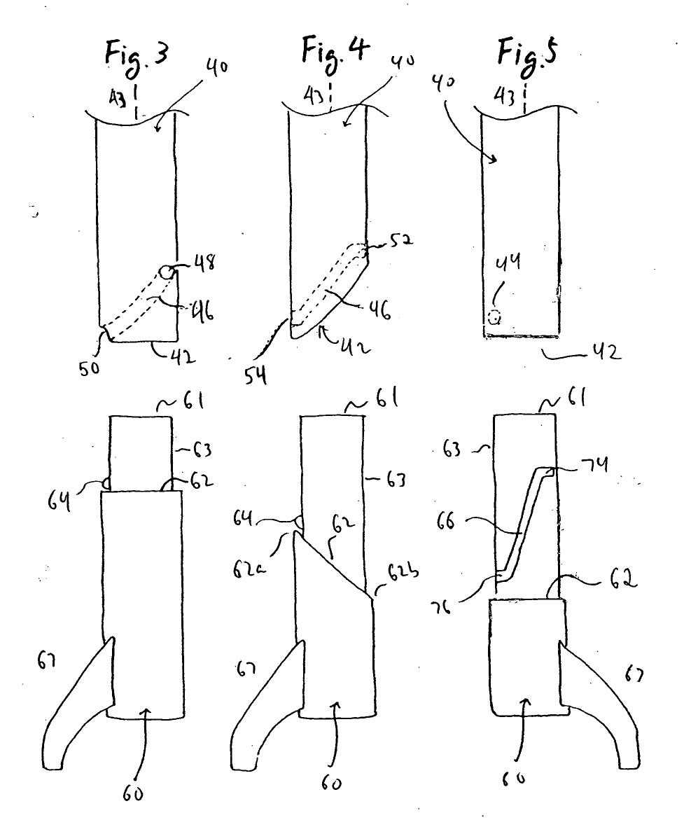

Referring to FIG. 3, a parking stand in accordance with a third preferred embodiment of the present invention is described. Although not shown in the figure, biasing spring 22 is again included and attached as described with respect to FIGS. 1, 1a and 2. Unlike the embodiments of FIGS. 1, 1a and 2, the engagement edges 42 and 62 are not sloped with respect to proximal member axis 43. However, like the embodiment of FIG. 2, proximal member 40 includes an axially-sloped slot 46 defined in its inner surface, and distal member 60 includes a boss projecting away from its outer surface. Cylindrical portion 63 is inserted in interior space 41 of proximal member 40 such that boss 64 engages slot 46. Thus, when distal member 60 is rotated about axis 43, boss 64 travels along slot 46. Because of the axial slope of slot 46, distal member 60 engages proximal member 40 at variable axial positions, causing distal member 60 to move axially. As with the embodiment of FIG. 2, parking stand 20 is in its compact position 100 when boss 64 is engaged with aperture 48 and is in its expanded position 120 when boss 64 is engaged with aperture 50.

Referring to FIG. 4, a parking stand is described in accordance with a fourth preferred embodiment of the present invention. In accordance with this embodiment, proximal member 40 and distal member 60 each include axially sloped engagement edges 42 and 62, respectively. In addition, axially-sloped slot 46 is formed in the inner surface of proximal member 40 and is designed to engage boss 64 therein. Unlike the embodiment of FIG. 3, slot 46 does not include apertures, but instead includes slot ends 52 and 54 which limit the range of travel of boss 64. Slot ends 52 and 54 are the termination points for the recess or groove in the inner surface of proximal member 40 which defines the slot. It is especially preferred that slot ends 52 and 54 have a substantially zero slope with respect to axis 43 to aid in restraining the axial movement of distal member 60 from proximal member 40 when boss 64 engages slot end 52 or slot end 54. A biasing spring 22 (not shown) is preferably included and is attached as shown in FIGS. 1 and 1a. Biasing spring 22 may either be a pulling spring that biases distal member 60 towards proximal member 40 or a pushing spring that biases distal member 60 away from proximal member 40. However, a pulling spring is preferred.

A fifth preferred embodiment of the parking stand of the present invention is described in FIG. 5. In accordance with this embodiment, parking stand 20 has a proximal member 40 and distal member 60 which respectively include engagement edges 42 and 62. In the embodiment of FIG. 5, engagement edges 42 and 62 are not axially-sloped. However, they may be axially-sloped if desired. Boss 44 is formed on the inner surface of proximal member 40 proximate to proximal member engagement edge 42 and projects inwardly from the inner surface. In this embodiment, boss biasing spring 72 is preferably omitted. An axially-sloping slot 66 is defined in the outer surface of cylindrical portion 63 of distal member 60 and is dimensioned to engage boss 44 therein when cylindrical portion 63 is inserted into interior space 41 of proximal member 40. Slot 66 preferably includes slot ends 74 and 76 which define expanded position 120 and compact-position 100, respectively. Slot ends 74 and 76 preferably have a substantially zero axial slope to aid in retaining distal member 60 to proximal member 40.

Because boss 44 is formed in proximal member 40, it does not rotate about axis 43. However, rotation of distal member 60 causes slot 66 to rotate. As a result, boss 44 engages slot 66 at variable axial positions on distal member 60, resulting in the movement of distal member 60 in the axial direction with respect to proximal member 40.

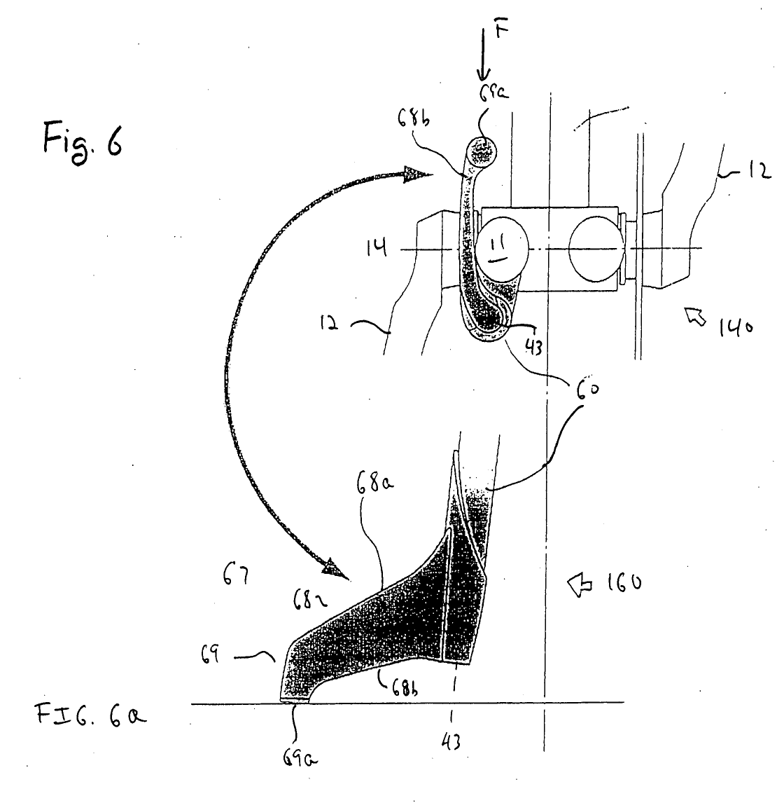

As best seen in FIGS. 1 and 6a, in a preferred embodiment of the present invention, parking stand 20 includes a support portion 67. Support portion 67 is preferably located at an end of parking stand 20 that is away from pivot axis 26 and distal member first end 61. Support portion 67 also preferably projects away from axis 43. It is further preferred that support portion 67 is integrally formed with distal member 60 such that it is rotatable with distal member 60.

As best seen in FIG. 6a, support portion 67 includes a projecting portion 68, which preferably has a top edge 68a and a bottom edge 68b. As shown in FIG. 6, the slope of top edge 68a with respect to proximal member axis 43 is preferably greater than the slope of bottom edge 68b.

Support portion 67 also includes a vertically depending portion 69, which is preferably spaced apart from proximal member axis 43. vertically depending portion 69 is approximately parallel to axis 43 and includes a ground contacting surface 69 which abuts the ground when the parking stand 20 is in the parking position 160. As best seen in FIG. 6, ground contacting surface 69a is preferably circular.

Referring to FIGS. 1 and 6, when parking stand 20 is in the riding position 140 and compact position 100, projecting portion 68 of supporting portion 67 is substantially parallel to frame 10. A bottom plan view of support portion 67 is provided in FIG. 6. In this view, parking stand 20 is in the riding position 140 and in the compact position 100. As the figure indicates, support portion 67 is preferably configured such that it partially wraps around adjacent frame member 11. This shape allows parking stand 20 to be attached to the bottom of adjacent frame member 11, while keeping-projecting portion 68 close to and approximately parallel to bicycle frame 10. As FIG. 6 indicates, when parking stand 20 is in the compact position 100 and the riding position 140, parking stand 20 is located sufficiently away from crank 12 that it minimizes or eliminates the likelihood that it will contact the rider's leg or ankle or otherwise impede his or her ability to pedal the bicycle.

FIG. 6a shows the parking stand 20 of this embodiment in the parking position 160. In the parking position 160, support portion 67 projects away from frame 10. It is especially preferred that support portion 67 is substantially perpendicular to frame 10. Ground engaging surface 69a is preferably circular (as shown in FIG. 6) and abuttingly engages the ground to support the vehicle.

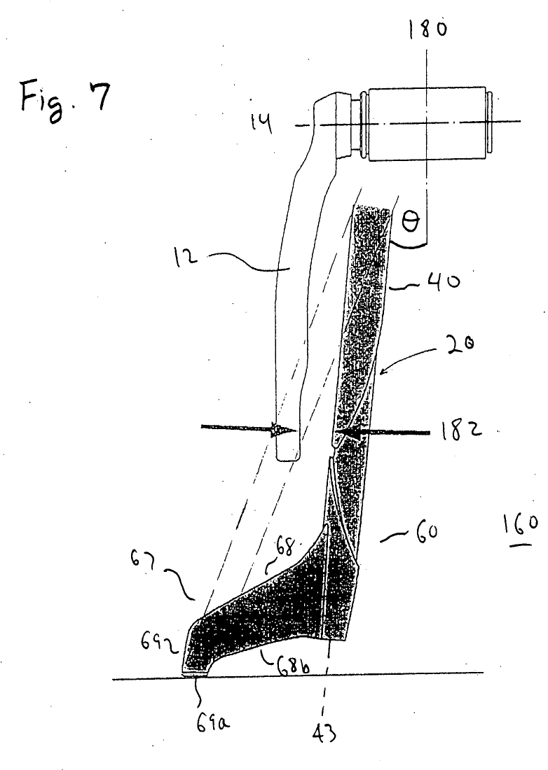

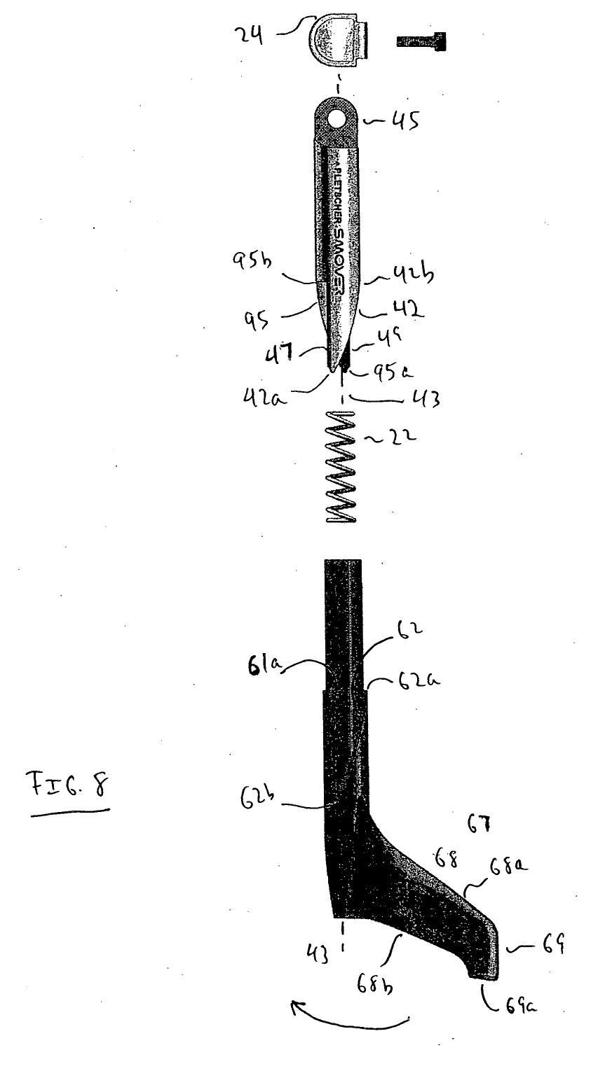

The parking stand 20 of this embodiment advantageously allows crank 12 to be rotated while parking stand 20 is in the parking position 160. Because of the support provided by supporting portion 67, parking stand 20 can provide sufficient support to the vehicle without being angled away from the frame 10 to the same extent required in many known parking stands. As best seen in FIG. 7, frame 10 defines a longitudinal plane 180. The angle θ defined between the parking stand 20 and longitudinal plane 180 of FIG. 7 is preferably relatively smaller than in known devices, whose orientation is represented in broken lines in the figure. Referring to FIG. 1, the length of crank 12 is longer than the distance between crank axis 14 and pivot axis 11. Thus, the rotational orbit of crank 12 overlaps with the rotational orbit of parking stand 20. However, the parking stand of this embodiment provides a lateral clearance 182 (see FIG. 7) between parking stand 20 and crank 12 which allows crank 12 to be rotated while parking stand 20 is in the parking position 160, notwithstanding the overlapping rotational orbits of crank 12 and parking stand 20. As a result, riders may walk the bicycle forward or backward without having to place parking stand 20 in riding position 140, providing added convenience.

A preferred embodiment of a method of using a parking stand in accordance with the present invention will now be described. While riding a vehicle on which parking stand 20 is installed, the rider preferably maintains parking stand 20 in the riding position 140 shown in FIGS. 1 and 6. As further indicated in FIG. 1, parking stand 20 is also preferably in its compact position 100 while the vehicle is being ridden. When the rider desires to park the vehicle, he preferably applies a clockwise pivotal force to distal member 60. This pivotal force will cause parking stand 20 to pivot about pivot axis 26 and will move parking stand 20 to the parking position 160. Pivot bracket 24 is preferably configured to restrain the range of clockwise pivot beyond the parking position 160 shown in FIG. 1, for example, by including an abutment in pivot bracket 26′ which prevents the rider from pivoting parking stand 20 beyond a predetermined limit.

It is especially preferred that while applying the foregoing rotational force, the rider also applies a rotational force to distal member 60 which is directed about proximal member axis 43. In the specific embodiment depicted in FIGS. 1 and 6, the rotational force would be applied in a direction that is counterclockwise with respect to proximal member axis 43 when viewing parking stand 20 from the rear of the vehicle, i.e., when viewing the bottom of supporting portion 67. As a result of the engagement of axially-sloped engagement edges 42 and 62, this rotational force will adjust parking stand 20 from the compact position 100 to the expanded position 120.

Although the foregoing method has been described with respect to the parking stand of FIGS. 1 and 1a, the parking stand 20 of FIG. 8 could also be used with the method of this embodiment. However, as explained above, the parking stand of FIG. 8 would only allow the rider to rotate distal member 60 in one direction when starting from the compact position 100. Also, if the parking stand 20 of FIGS. 2-4 were used, the rotational force about axis 43 would cause boss 64 to travel along slot 46. The movement of boss 64 along axially sloped slot 46 would cause the distal member 60 to move axially away from the proximal member 40 in the manner described previously. Similarly, if the parking stand 20 of FIG. 5 were used, the rotational force about axis 43 would cause slot 66 to move with respect to boss 44 to cause the axial displacement of distal member 60, as described above.

In performing the method of this embodiment, the rider preferably uses his or her foot to apply the foregoing pivotal and rotational forces to support portion 67 of distal member 60. In the embodiment of FIG. 6, vertically depending portion 69 is positioned above adjacent frame member 11. Thus, by applying a downward force to vertically depending section 69, the rider can pivot parking stand 20 into the parking position 160. Similarly, the positioning of vertically depending portion 69 above adjacent frame member 11 allows the rider to use his or her foot to apply a counterclockwise rotational force to supporting 67.

In an especially preferred embodiment, the rider applies the pivotal and rotational forces to support portion 67 with a single movement of the foot, thereby simultaneously adjusting the parking stand 20 from its riding position 140 and compact position 100 to its parking position 160 and expanded position 120. As best seen in FIG. 6, when parking stand 20 is in its compact position 100 and its riding position 140, vertically depending section 69 is slightly offset from proximal member axis 43 in a direction away from frame 10. As a result, a downward force F may be applied to vertically depending section 69 which will create a torque about both pivot axis 26 and about proximal member axis 43, thereby allowing the concurrent pivoting and rotation of parking stand 20 with a single motion of the foot.

The embodiments described above are exemplary embodiments of a the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A parking stand, comprising:
a first member having a first member axis defining an axial direction; and
an unthreaded second member, operatively connected to the first member and rotatable about the first member axis, wherein rotating the second member about the first member axis causes the second member to move in the axial direction relative to the first member.

2. The parking stand of claim 1, wherein the second member further comprises a support portion spaced apart from the first member, and the support portion projects away from the first member axis.

3. The parking stand of claim 1, wherein the second member is biased with respect to the first member in the axial direction.

4. The parking stand of claim 3, wherein the second member is biased away from the first member.

5. The parking stand of claim 3, wherein the second member is biased towards the first member.

6. A parking stand, comprising:
a first member having a first member axis defining an axial direction, the first member having a first engagement edge with a slope in the axial direction; and
a second member having a second engagement edge with a slope in the axial direction, wherein the second member is rotatable about the first member axis, and the second engagement edge abuttingly engages the first engagement edge.

7. The parking stand of claim 6, wherein the first engagement edge abuttingly engages the second engagement edge such that rotating the second member about the first member axis causes the second member to move in the axial direction relative to the first member.

8. The parking stand of claim 6, wherein one of the first and second members has a boss, the other of the first and second members has a slot with a slope in the axial direction, and the boss engages the slot.

9. The parking stand of claim 8, wherein the parking stand has a compact position and an expanded position, and the slot has a first end defining the compact position and a second end defining the expanded position.

10. The parking stand of claim 8, wherein the second member has the boss and the first member has the slot.

11. The parking stand of claim 8, wherein the first member has the boss and the second member has the slot.

12. The parking stand of claim 8, wherein the first member and the second members each have an inner surface and an outer surface, the boss projects away from the outer surface of one of the first and second members, and the slot is defined in the inner surface of the other of the first and second members.

13. The parking stand of claim 6, wherein the second member is biased with respect to the first member in the axial direction.

14. The parking stand of claim 13, wherein the second member is biased toward the first member.

15. The parking stand of claim 13, wherein the second member is biased away from the first member.

16. The parking stand-of claim 6, wherein the second member has a support portion spaced apart from the first member, and the support portion projects away from the first member axis.

17. The parking stand of claim 8, wherein the rotation of the second member causes the boss to travel along the slot.

18. The parking stand of claim 8, wherein said one of the first and second members having a boss further has an outer surface and an aperture, and the boss is biased through the aperture in a direction away from the outer surface.

19. The parking stand of claim 9, wherein the first end of the slot has a first end-aperture and in the compact position, the boss projects through the first end aperture.

20. The parking stand of claim 19, wherein the second end of the slot has a second end aperture and in the expanded position the boss projects through the second end aperture.

21. A parking stand, comprising:
first and second members, one of said first and second members being rotatable relative to the other of said first and second members;
wherein the first member has a first member axis defining an axial direction and further has a first member slot with a slope in the axial direction, wherein the second member has a second member boss, and the second member boss is engaged with the first member slot such that rotating one of the first and second members about the first member axis causes the rotated member to move in the axial direction-relative to the other of the first and second members.

22. The parking stand of claim 21, wherein the first member is rotatable relative to the second member.

23. The parking stand of claim 21, wherein the second member is rotatable relative to the first member.

24. The parking stand of claim 21, wherein the parking stand has a compact position and an expanded position, and the slot has a first end defining the compact position and a second end defining the expanded position.

25. The parking stand of claim 21, wherein the first member has a first member edge with a slope in the axial direction, the second member has a second member edge with a slope in the axial direction, and the first member edge abuttingly engages the second member edge.

26. The parking stand of claim 21, wherein rotating one of the first and second members causes the boss to travel along the slot.

27. The parking stand of claim 21, wherein the second member is biased with respect to the first member in the axial direction.

28. The parking stand of claim 27, wherein the second member is biased toward the first member.

29. The parking stand of claim 27, wherein the second member is biased away from the first member.

30. The parking stand of claim 21, wherein one of the first and second members has a support portion spaced apart from the other of the first and second members, and the support portion projects away from the first member axis.

31. The parking stand of claim 21, wherein the first member has an inner surface and the second member has an outer surface, the boss projects away from the outer surface of the second member, and the slot is defined in the inner surface of the first member.

32. The parking stand of claim 21, wherein the first member has an outer surface and the second member has an inner surface, the boss projects inwardly from the inner surface of the second member and the slot is defined in the outer surface of the first member.

33. The parking stand of claim 21, wherein the second member has an outer surface and an aperture, and the boss is biased through the aperture in a direction away from the outer surface of the second member.
